(19) United States
(12) Patent Application Publication
(10) Pub. No.: US 2007/0215548 A1
(43) Pub. Date: Sep. 20, 2007

(54) Systems and methods for packing chromatography columns

(76) Inventor: Joe Xin Hua Zhou, Westlake, CA (US)

Correspondence Address: OLYMPIC PATENT WORKS PLLC, P.O. BOX 4277, SEATTLE, WA, 98104, US

(21) Appl. No.: 11/650,291

(22) Filed: Jan. 5, 2007

Related U.S. Application Data
(60) Provisional application No. 60/756,388, filed on Jan. 5, 2006.

(51) Int. Cl. B01D 15/08

(52) U.S. Cl. 210/656

(57) ABSTRACT

Various embodiments of the present invention are directed to systems and methods for packing chromatography columns. In one described embodiment of the present invention, a compressible resin is combined with a relatively high-viscosity packing solution to form a resin slurry for packing within a chromatography-column tube. In an alternative embodiment of the present invention, a relatively high-viscosity column-compression solution is used to compress a chromatography column initially packed with a dilute aqueous solution.

### CROSS-REFERENCE TO RELATED APPLICATION

This application claims the benefit of U.S. Provisional Application No. 60/756,388, filed Jan. 5, 2006.

### TECHNICAL FIELD

The present invention is related to packing of chromatography columns, and, in particular, to packing chromatography columns with compressible resins.

### BACKGROUND OF THE INVENTION

Column chromatography is a commonly used technique for purification of particular types of molecules from complex sample solutions and complex sample mixtures that include solutes and suspended or partially solvated chemical entities, such as membrane fragments. A chromatography column is prepared by suspending a resin in a buffer solution to form a resin slurry, and then packing the resin slurry within a chromatography tube to form a matrix within the chromatography tube by following a packing procedure, or packing mode. The matrix constitutes the solid phase or stationary phase within the chromatography column.

A chromatography column is generally incorporated within a chromatography system that includes one or more pumps, eluate collectors, and detectors. Column chromatography systems are frequently used for purifying biomolecules, including proteins and other biopolymers, from complex solutions and mixtures, such as, for example, purifying recombinant proteins from cell lysates and cell filtrates.

A complex solution that contains one or more types of molecules to be purified, each type referred to as a “target molecule,” is loaded onto the chromatography column in which buffer conditions are established to promote separation of the one or more target molecules from the complex solution. A buffer solution, or mobile phase, is then directed through the chromatography column to move desired target molecules and undesired sample-solution components through the chromatography column. Different types of solutes move through the chromatography column at different rates, depending on their different mobilities in, and different affinities for, the mobile phase and the stationary phase, resulting in separation of the one or more target molecules from solutes and suspended entities present in the original sample solution. Solutions containing the one or more target molecules, referred to as “eluates,” are subsequently eluted from the chromatography column.

Various problems are encountered in using column chromatography to purify proteins. Backpressure, a force opposing the forward flow of buffer through the chromatography column, may develop both during packing of a chromatography column and during target-molecule purification. In certain cases, excessive backpressure may decrease both the speed of packing and the efficiency and yield of the column-chromatography-based purification process. Matrixes prepared from soft resins, such as agarose-based resins, are prone to generation of excessive backpressure during purification processes. As a result, researchers, pharmaceutical manufacturers, chromatography-column resin manufacturers and vendors, and users of chromatography-based purification methods have recognized the need for improved methods for packing chromatography columns with resins for use in chromatography-based purification processes.

### SUMMARY OF THE INVENTION

Various embodiments of the present invention are directed to systems and methods for packing chromatography columns. In one described embodiment of the present invention, a compressible resin is combined with a relatively high-viscosity packing solution to form a resin slurry for packing within a chromatography-column tube. In an alternative embodiment of the present invention, a relatively high-viscosity column-compression solution is used to compress a chromatography column initially packed with a dilute aqueous solution.

### BRIEF DESCRIPTION OF THE DRAWINGS

FIG. 1 is a control-flow diagram that describes a method for preparing a resin slurry and packing a chromatography column with a resin slurry that represents one of many embodiments of the present invention.

FIG. 2 illustrates a pressure/flow chart for an agarose-resin-based chromatography-column system.

FIGS. 3A-B illustrate advantages of high-viscosity-packing-solution-based column-packing methods of the present invention.

### DETAILED DESCRIPTION

Various embodiments of the present invention are directed to systems and methods for packing chromatography columns with resins, including compressible resins, or soft resins, such as agarose-based resins. These embodiments are described, below, following description of a chromatography-based-process context in which embodiments of the present invention may be applied.

### Chromatography-Based-Process Context

Various method embodiments of the present invention apply to any of a variety of chromatographic methods including ion-exchange chromatography, size-exclusion chromatography, hydrophobic interaction chromatography, and affinity chromatography. In ion-exchange chromatography, a target molecule is separated from a complex solution or mixture based on electrostatic forces between charged functional groups of target molecules and charged functional groups of the chromatography-column matrix. Cation-exchange resins have negatively charged functional groups that attract positively charged functional groups of target molecules, and anion-exchange resins have positively charged functional groups that attract negatively charged functional groups of target molecules. Molecules bound through electrostatic forces to the matrix can be eluted by increasing the ionic strength of the buffer solution within the chromatography column over time. In size-exclusion chromatography, a target molecule is separated from a complex solution or mixture based on the target molecule's size-related exclusion from the interior regions of spherical beads that make up the matrix. Progress through the chromatography column of smaller molecules that are capable of diffusing into the beads is slowed with respect to the target molecule. In hydrophobic interaction chromatography, a target molecule is separated from a complex solution or mixture based on the hydrophobicity of the target molecule. A complex solution containing the target molecule is applied to a chromatography column equilibrated with a high salt buffer that facilitates binding of the target molecule to the resin. A salt-gradient mobile phase with decreasing ionic strength is then introduced into the chromatography column to release bound target molecules from the matrix. Alternatively, hydrophobic interaction chromatography may separate a monomeric target molecule from a complex solution or mixture by binding hydrophobic impurities, including inactive dimers and aggregates of the target molecule, while permitting monomeric target molecules to flow through the chromatography column relatively unimpeded. In affinity chromatography, a target molecule, such as an antibody, is separated from a complex solution based on the affinity of the target molecule for a ligand or ligand-binding entity that is covalently bound to the matrix. Molecules in the complex solution or mixture with weak affinity, or lacking affinity, for the ligand or ligand-binding entity flow through the chromatography column unimpeded, leaving the target molecule bound to the matrix. The target molecule can then be eluted from the chromatography column by altering buffer conditions to decrease the affinity of the target molecule for the ligand or ligand-binding entity.

Protein A is a ˜41 kDa protein from Staphylococcus aureas that binds with high affinity (˜10⁻⁸ M-10⁻¹² M to human IgG) to the C_{H}2/C_{H}3 domain of the Fc regions of antibodies and is therefore commonly immobilized within an affinity-chromatography matrix for purifying target antibodies. Due to the biochemical properties of protein A, including a lack of disulfide bond linkages, protein A is very stable and can be used with high salt conditions and/or denaturants, such as 10 M urea, 6 M guanidine, and 80 mM dithiothreitol. Protein-A affinity chromatography is often used for purification of monoclonal antibodies and fusion proteins containing the antibody constant fragment Fc. About 98% of process impurities, including viral particles, can be removed by protein-A affinity column chromatography in a single step, with high product yields.

There are many commercially available protein-A affinity chromatography resins that may be used for antibody purification, including ProSep® controlled-pore glass resins produced by Millipore and MabSelect™ cross-linked agarose resin products produced by Amersham Biosciences. Both MabSelect and ProSep resins are claimed to have dynamic binding capacities approaching greater than 20 g/L, linear flow velocities for producing commercial quantities of antibodies ranging from 200 to 600 cm/hr, and pH stabilities from about 2 to about 10. Both types of resin are chemically stable when exposed to urea and other reducing agents.

Controlled-pore glass-based and silica-based resins are commonly used as chromatography resins due to their high mechanical strengths, high chromatography-column efficiencies, and controllable particle sizes. However, interactions between controlled-pore glass-based and silica-based resins and hydrophobic portions of certain impurities found in complex solutions and mixtures, including Chinese hamster ovary protein (“CHOP”), may inhibit the separation of Fc-containing target molecules from the impurities. This separation inhibition is commonly observed in glass-resin-based protein-A affinity chromatography.

Soft resins, such as agarose-based resins, may have more favorable characteristics for purifying Fc-containing target molecules from impurities with hydrophobic domains. Members of the MabSelect family of agarose-based protein-A resins are composed of highly cross-linked hydrophilic agarose particle of sizes from 40-130 μm. The ligand used in MabSelect is a recombinant protein A expressed in Escherichia coli. Soft resins, such as MabSelect, are, in general, less dense and more hydrophilic than glass-based and silica-based resins and, consequently, may require longer equilibration and packing times. Although MabSelect is reported to have adequate separation as a chromatography-column resin at up to 500 cm/hr and to provide adequate CHOP clearance, a higher operational backpressure is often generated during commercial antibody preparation in MabSelect-based chromatography columns than for chromatography columns that employ controlled-pore-glass-resin-based and silica-resin-based matrixes. High operational backpressures are also generated in chromatography columns with matrixes prepared from other agarose-based resins and soft resins, particularly in commercial processes using chromatography columns with large volumes. Packing tall chromatography columns with relatively soft resins, such as agarose-based resins, may be particularly problematic. Because of the cost of protein-A-based resins, the column chromatography step or steps of a purification process may be limiting steps with regard to economical efficiency of a purification process. A purification process that includes significantly non-optimal protein-A-based chromatography steps, including steps with relatively low yields, steps that involve relatively slow preparation and slow operation, and steps with other problems, may lead to economically unfavorable or economically unfeasible purification processes.

### Described Embodiments of the Present Invention

Generation of excessive operational backpressure in column-chromatography systems, including column-chromatography systems that employ matrixes prepared from agarose-based resins and other soft resins, may be decreased or eliminated by employing a packing-method embodiment of the present invention. In additional embodiments of the present invention, the equilibration buffer, packing mode, and flow rate of a chromatography column are adjusted to limit backpressure and improve efficiency of the purification process.

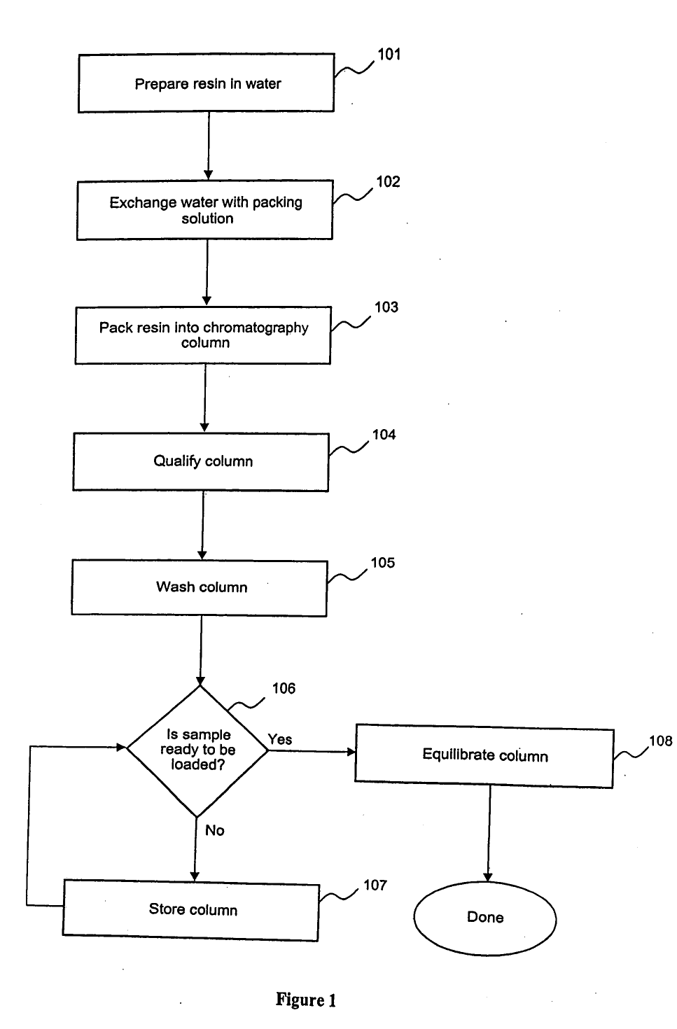

FIG. 1 is a control-flow diagram that describes a method for preparing a resin slurry and packing a chromatography column with a resin slurry that represents one of many embodiments of the present invention. In step 101, a resin is suspended in water to remove organic solvents in which the resin is shipped from the manufacturer.

In step 102, the water in the resin is exchanged with a packing solution to produce a resin slurry. The packing solution contains a relatively high concentration of at least one salt that imparts a relatively high viscosity to the packing solution. In currently used packing protocols, packing solutions commonly contain between 0.1M and 1.0M NaCl. By contrast, in the currently described embodiment, the packing solution contains a relatively high concentration, between about 0.8 M and 1.2 M, of sodium sulfate, Na₂SO₄. Na₂SO₄, with an anhydrous molar mass of 142.04 g/mol and a density of 2.6-2.8 g/cm³, is generally nontoxic, very stable, and does not readily decompose, even when heated. Na₂SO₄ does not react with oxidizing or reducing agents under normal temperatures. Na₂SO₄ is a neutral salt, with a pH between 6 and 7 when dissolved in water, and dissociates in aqueous solutions into Na⁺ and SO₄²⁻ ions. The presence of a relatively high salt concentration of Na₂SO₄ increases the viscosity of the packing solution, which can, in turn, decrease backpressure and increase chromatography-column efficiency.

A salt is considered to be a high-viscosity-imparting salt when a solution of a particular molarity of the high-viscosity-imparting salt has a viscosity greater than an equimolar solution of NaCl. For example, a 0.603M solution of Na₂SO₄ has a viscosity of 1.286 centipoise, a 0.768M solution of Na₂SO₄ has a viscosity of 1.387 centipoise, and a 1.025M solution of Na₂SO₄ has a viscosity of 1.571M. By contrast, a 0.995M solution of NaCl has a viscosity of 1.094 centipoise, a 2.432M solution of NaCl has a viscosity of 1.28 centipoise, a 3.056M solution of NaCl has a viscosity of 1.385 centipoise, and a 3.928M solution of NaCl has a viscosity of 1.554M. At concentrations of Na₂SO₄ between about 0.8 M and 1.2 M, Na₂SO₄ has a significantly greater viscosity than an equimolar NaCl solution. Examples of alternative, high-viscosity-imparting packing-solution salts that may be used in alternative embodiments of the present invention include sulfate salts of potassium and magnesium. In alternative embodiments of the present invention, high-viscosity-imparting packing-solution salts may be used in concentrations of between 0.5M and 2M. High-viscosity-imparting packing-solution salts used in embodiments of the present invention are deemed suitable when packing solutions containing concentrations of between 0.1M and 2M of the high-viscosity-imparting packing-solution salts result in chromatography columns that generate less operational backpressure during target-molecule purification than chromatography columns packed with equivalent packing solutions containing an equimolar concentration of NaCl.

In step 103, the resin slurry is packed into a chromatography-column tube. The resin slurry may be poured into the chromatography-column tube in a continuous fashion, applying packing solution at a fixed rate of flow in order to avoid forming resin layers. Excess packing solution is effluxed from the bottom of the chromatography-column tube while the resin is packed into the chromatography-column tube. The resin slurry may then be allowed to pack into a tight bed in the chromatography-column tube either in the presence or absence of continued packing-solution flow. In one embodiment of the present invention, packing-solution flow is used to actively facilitate the packing of the resin into the chromatography-column tube in a process referred to as “flow packing” or “even distribution.” In another embodiment of the present invention, the resin is allowed to pack in the tube in the absence of packing-solution flow in a process referred to as “gravity flow” or “settlement distribution.” Since various resins used in column chromatography differ in density, hydrophobicity, and rigidity, resins often differ in the rate and uniformity with which they settle into the chromatography-column tube. In one embodiment of the present invention, a packing-solution linear velocity of about 350-450 cm/hr is used for packing the chromatography column. Employing a relatively large, constant packing-solution linear velocity may increase the speed at which a resin can be packed, and may also improve the uniformity of packing of the resin. Maintaining a relatively large, constant packing-solution linear velocity may help ensure that the operational backpressure is suitable for sample loading and elution.

In step 104, the chromatography column is washed with a washing solution to remove the packing solution introduced into the chromatography column in step 103. In one embodiment of the present invention, the washing solution is water.

In a qualification step 105, the quality and separation efficiency of the packed chromatography column are monitored to ensure that these qualification values are being maintained within acceptable limits. Packing backpressure may typically develop as the flow rate increases. In order to maintain the integrity of the packed chromatography column, the packing backpressure in the chromatography column may be limited to a backpressure at or below a threshold backpressure. In one embodiment of the present invention, a buffer solution containing about 0.1 M-1.0 M NaCl or acetone is passed through the chromatography column during the qualification step. The chromatography column is commonly verified and qualified for the absence of pouring defects, including air or liquid voids or structural irregularities, by loading standard molecules onto the packed chromatography column and eluting the standard molecules from the chromatography column. While standard molecules should theoretically elute in a Gaussian concentration distribution, various factors, such as chromatography-column packing irregularities or suboptimal flow conditions, may result in standard molecules eluting in a skewed concentration distribution. Pouring defects may be more likely to occur in tall chromatography columns. Such pouring defects are likely to cause back-mixing of the fluids, limit sample resolution, and decrease chromatography-column capacity and efficiency. Physical chromatography-column characteristics, including peak asymmetry and the height equivalent of the theoretical plate (“HETP”), may be measured in step 105 to identify the quality the packed chromatography column and monitor separation resolution of the packed chromatography column.

In step 106, the chromatography column is cleaned by washing the chromatography column with a cleaning solution of up to 5 column volumes. Cleaning of the packed chromatography column, referred to as “cleaning-in-place” or “CIP,” may assist in removing contaminants from the matrix after the matrix has been formed by packing the resin into the chromatography-column tube but before a sample solution has been loaded. In one embodiment of the present invention, the cleaning solution contains a base, such as 0.05 M sodium hydroxide in 0.5 M sodium sulfate.

In step 107, the chromatography column is washed with a washing solution to remove the cleaning solution used in step 106 from the chromatography column. In one embodiment of the present invention, the washing solution is water.

When the chromatography column is not intended for immediate use, as determined in step 108, the qualified and cleaned chromatography column is stored in step 109. In one embodiment of the present invention, the chromatography column is stored at 4° C. in a storing solution containing up to about 2% benzyl alcohol and 0.1 M sodium acetate, pH ˜5. Otherwise, the chromatography column is equilibrated in step 110. In one embodiment of the present invention, an equilibration buffer containing up to about 20 mM 2-amino-2-hydroxymethyl-1,3-propanediol (“Tris”) and 100 mM NaCl, pH 7.2 is used for equilibration.

In an alternative embodiment of the present invention, a chromatography column can be packed using water or a dilute aqueous buffer as the packing solution, resulting in a first packing, and can then be further compressed by passing a column-compression solution containing a relatively high concentration of a high-viscosity-imparting salt through the column, in an additional compression step following initial packing. The high-viscosity-imparting salt, such as 1M Na₂SO₄, may be present at a concentration of between 0.5M and 2M, in certain embodiments of the present invention.

Following equilibration, the chromatography column is ready for sample loading. When embodiments of the present invention are used to purify Fc-containing target molecules from a sample solution or mixture via affinity-chromatography, a loading buffer with a high salt concentration, such as a salt concentration greater than about 250 mM, is used in order to facilitate binding of the Fc-containing target molecule to the immobilized protein A. Once the sample is loaded, an elution buffer is used to elute the Fc-containing target molecule from the chromatography column. In one embodiment of the present invention, the elution buffer has a low pH, and therefore disrupts interactions between the protein-A matrix and the Fc-containing target molecule. Examples of buffers that may control the pH within a suitable range for protein-A affinity column chromatography include phosphate, acetate, citrate, and sulfate salts of sodium, lithium, potassium, and ammonia, or combinations of the above salts.

Maximizing chromatography-column efficiency includes optimizing residence time of a target molecule within the chromatography column and optimizing the linear velocity of the elution buffer. Since higher flow rates may reduce the time during which the target molecule resides inside the chromatography column, there is the potential for larger flow rates to decrease chromatography-column capacity. Residence time is the time required for a target molecule to pass through a chromatography column. Optimal residence times generally represent balances between the benefit of eluting a target molecule from the chromatography column swiftly, using large flow rates, and the benefit of increasing the target-molecule capacity of the chromatography column by using relatively smaller flow rates. A relatively low flow rate may have additional advantages. For example, 5 column volumes of loading buffer applied to a chromatography column prepared with a MabSelect-resin-based matrix at a linear velocity of 150 cm/hr achieves a high level of purification, as measured by DNA and CHOP clearance. 10 column volumes of loading buffer applied to a chromatography column prepared with a MabSelect-resin-based matrix achieves a similar purification level when the same chromatography column is operated with a linear flow velocity of 500 cm/hr. In one embodiment of the present invention, a tall chromatography-column resin bed with a relatively large capacity and a comparatively slow flow rate is used to maximize the antibody capacity of a chromatography column prepared with an agarose-based-resin matrix.

Once a target molecule is eluted from a column prepared according to an embodiment of the present invention, one or more techniques may be employed to further purify the target molecule. Examples of other techniques include polishing steps, such as additional chromatography steps or procedures, membrane filtration, dialysis, and electrophoresis. Thus, for example, a procedure for purifying an antibody containing a C_{H}2/C_{H}3 region from a cell lysate using a column prepared by the packing method illustrated in FIG. 1 may include an initial purification step, often referred to as a “capture step,” and one or more polishing steps. The capture step may include packing a resin having immobilized protein A into a chromatography column, as described above, loading the antibody on the column, removing contaminants by washing the solid phase with a suitable wash buffer, and recovering the antibody from the solid phase with a suitable elution buffer. The effectiveness of the capture step may be assessed based on the speed of the chromatography process, the degree of separation of the target molecule from undesired solutes and suspended entities, and the load capacity of the chromatography column. Chromatography resins with high load capacities and good flow properties may be particularly well-suited for capture steps. The polishing step or steps may separate the target protein that has been concentrated and initially purified in the capture step from remaining impurities. Flow rates and load capacities of the polishing steps are often restricted in order to optimally improve resolution. The polishing steps may achieve further purity and eliminate contaminants, such as aggregates and viral particles, and may also be used to adjust buffer conditions.

### EXAMPLE 1

To provide a base point for evaluating the effectiveness of methods of the present invention, an agarose-based column-chromatography resin MabSelect™ was prepared in a 1 M NaCl buffer and packed into a 20 cm by 50 cm chromatography-column tube to form a resin bed with a diameter of 20 cm and a height of 30 cm using an even distribution mode according to a conventional column-preparation method. A relatively large linear flow velocity of 450 cm/hr was used to pack the chromatography column. Using standard chromatography-column qualification procedures, an HETP of 0.059 and an asymmetry of 1.24 were observed, which were within previously identified acceptable qualification ranges to support affinity chromatography.

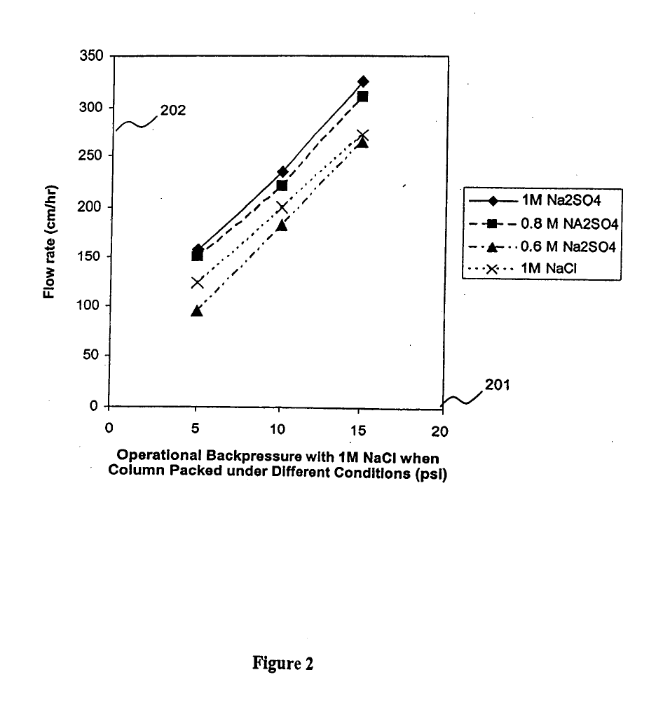

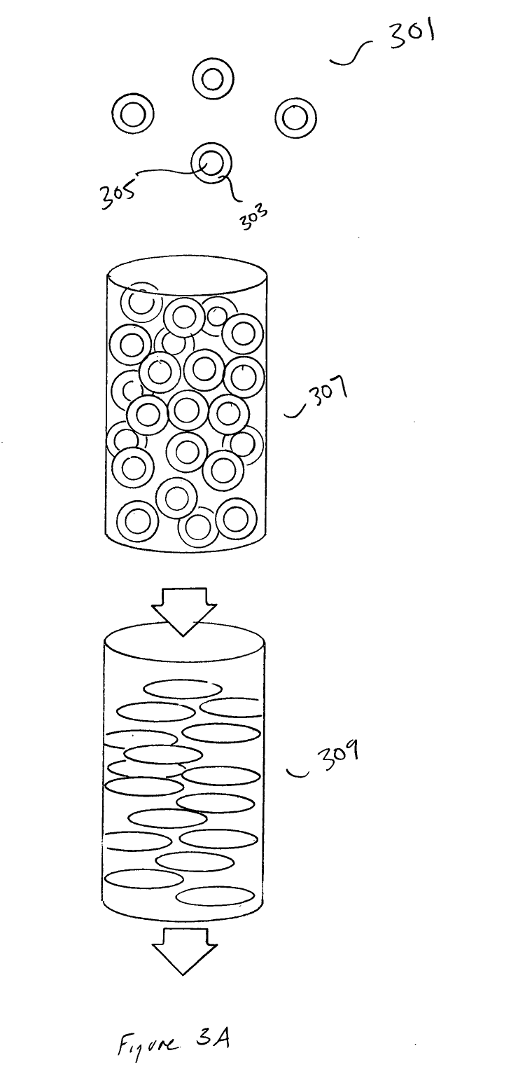

FIG. 2 illustrates a pressure/flow chart for an agarose-resin-based chromatography-column system. The x axis 201 of the graph indicates the operational backpressure. The y axis 202 of the graph indicates the observed flow rate. When the packed chromatography column was qualified with a 1 M NaCl qualification solution at an operational flow rate/linear velocity of 300 cm/hr, approximately 13-15 psi of backpressure was measured. When the backpressure was set at 5, 10, or 15.5 psi, the observed flow rate was 124 cm/hr, 200 cm/hr, and 271 cm/hr, respectively. The chromatography column was successfully employed for the purification of a monoclonal antibody expressed in Chinese hamster ovary (“CHO”) cells.

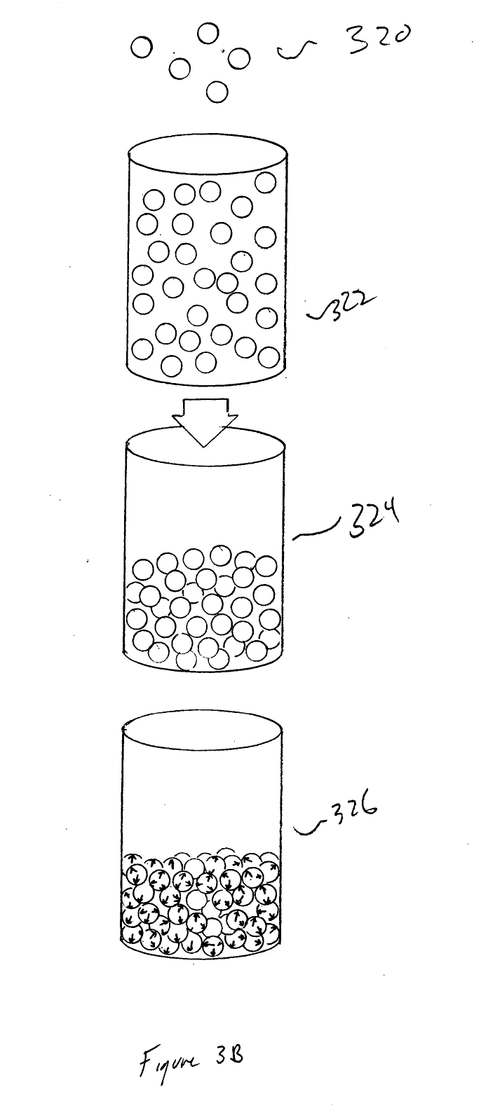

FIGS. 3A-B illustrate advantages of high-viscosity-packing-solution-based column-packing methods of the present invention. In FIG. 3A, conventional column packing is illustrated. The resin beads 301 are highly hydrated in a standard packing solution, as illustrated in FIG. 3A by outer, hydrous spheres (e.g. 303) surrounding each resin-bead core (e.g. 305). When the highly hydrated resin beads are incorporated into a resin slurry and poured into a column, the resin beads remain highly hydrated and relatively loosely packed. A loosely packed column section 307 is abstractly illustrated in FIG. 3A. In an actual chromatography column, the radii of the resin beads are far smaller than the dimensions of the chromatography column. An abstract illustration, with exaggerated resin-bead dimensions, is employed in FIG. 3A for clarity of illustration, and is not intended to reflect actual relative dimensions of resin beads with respect to the chromatography column in which they are contained. When pressure is applied to the chromatography column and the matrix contained within the column, as illustrated in column section 309, the highly hydrated resin beads tend to flatten, and compress, impeding the flow of solution through the column, and generating significant operational back pressure. This phenomenon occurs particularly in the upper and lower extremities of the column, where greatest pressure develops during column operation. Therefore, column section 309 can be considered to illustrate an upper or lower section of a chromatography column.

By contrast, as shown in FIG. 3B, when resin beads are suspended in a highly-viscous packing solution, according to embodiments of the present invention, they are generally less hydrated, as illustrated in FIG. 3B by smaller resin beads without hydration shells 320. When a high-viscosity resin slurry is poured into a column, illustrated by column section 322 in FIG. 3B, and when pressure is then applied, illustrated by column section 324 in FIG. 3B, the resin beads become tightly packed, with a concomitant decrease in the volume of the column matrix. However, the resin beads are less plastic than the highly hydrated resin beads produced by conventional techniques, and shown in FIG. 3A, and retain their spherical symmetry and dimensions. Moreover, as shown in column section 326, when the high-viscosity packing solution is washed from the column, following packing, and replaced by a dilute eluant or equilibration buffer, the tightly packed resin beads are locked into place by expansion forces within the resin beads generated within the resin beads by a tendency for the resin beads to expand and attract hydration spheres in the more dilute, aqueous environment of the dilute eluant or equilibration buffer. This internal tension within the matrix tends to lock the resin beads together, and impart significant resistance, within the matrix, to compression when pressure is again applied during purification procedures. Thus, resin beads packed in high viscosity packing solutions according to methods of the present invention are less prone to deformation and compression, and are, in addition, locked into a more stable, pressure-resistant matrix when the high-viscosity packing solution is replaced by a dilute eluant or equilibration buffer.

In order to improve the chromatography-column characteristics and flow conditions of the MabSelect-based chromatography column by a method embodiment of the present invention, three concentrations (0.6 M, 0.8 M, and 1.0 M) of Na₂SO₄ were employed in three different packing solutions. Chromatography columns prepared in these packing solutions were tested for asymmetry, HETP, and operational backpressure. A linear flow velocity of 450 cm/hr was used for packing the chromatography column and a linear flow velocity of 300 cm/hr used to operate the chromatography column. The packed chromatography columns were tested for operational backpressure, and the chromatography-column characteristics and achievable operational flow rate under various backpressures are listed below in Table 1 and in FIG. 2.

TABLE 1
Characterization of Na₂SO₄ as a High-Viscosity-Imparting
Salt for an Agarose-Based Liquid Chromatography
Resin Packing Solution.

| | Operational | | | Operational Flow Rate | | |
|---|---|---|---|---|---|---|
| Na₂SO₄ | Backpressure | Asymmetry | | (cm/hr) | | |
| (M) | (psi) | (Aₛ) | HETP | 5 psi | 10 psi | 15.5 psi |
| 1.0 | 32.5 | 1.03 | 0.024 | 157.6 | 234 | 325 |
| 0.8 | 25.0 | 1.58 | 0.021 | 150 | 220 | 311 |
| 0.6 | 28.0 | 0.92 | 0.017 | 95.5 | 182 | 264 |

Since the natural pH of Na₂SO₄ solutions is about 6.5, there was no need to adjust and/or titrate the pH of the packing solution. A higher flow rate is achieved with packing solutions employing high concentrations of Na₂SO₄ for each operational backpressure tested. Based on the data obtained, the operational backpressure for a humanized monoclonal antibody was estimated to be about 8-16 psi for a 20 cm by 30 cm chromatography column and about 14-22 psi for a 30 cm by 30 cm chromatography column, using an elution-buffer linear velocity of about 200-300 cm/hr.

Although the present invention has been described in terms of a particular embodiment, it is not intended that the invention be limited to this embodiment. Modifications within the spirit of the invention will be apparent to those skilled in the art. For example, in an alternate embodiment of the present invention, the packing, qualification, and elution solutions may contain additional salts in addition to those listed, and organic solvents may also be present in the various buffers, solutions, and eluants employed for preparing and using a chromatography column. The chromatography resin packed by packing-method embodiments of the present invention may be an agarose-based resin, as discussed above, or another resin that, when used to produce a column chromatography matrix, may result in increased operational backflow during chromatography-column operations.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to explain the principles of the invention and its practical applications, to thereby enable others skilled in the art to best utilize the invention and various embodiments with various modifications as are suited to the particular use contemplated.

1. A method for packing a protein-A affinity chromatography column, the method comprising:
preparing a resin slurry by suspending a chromatography resin in a packing solution that contains a high-viscosity-imparting Na₂SO₄ concentration of between 0.8 M and 1.2 M to form a high-viscosity resin slurry;
pouring the high-viscosity resin slurry into a column-chromatography tube to form the chromatography column;
packing the chromatography column by introducing packing-solution into the chromatography column; and
washing the packing-solution from the chromatography column.

2. The method of claim 1, wherein the chromatography resin is an agarose-based resin.

3. The method of claim 1, wherein the chromatography resin is an agarose-based protein-A resin composed of highly cross-linked hydrophilic agarose particle of sizes from 40-130 μm to which a recombinant protein A is bound.

4. The method of claim 1 wherein the packing-solution is continuously introduced into the chromatography column under pressure.

5. A packed protein-A affinity chromatography column prepared by the method of claim 1 wherein
when the packed protein-A affinity chromatography column is not intended for immediate use, the packed protein-A affinity chromatography column is stored at below 4° C. in a storing solution containing up to about 2% benzyl alcohol and 0.1 M sodium acetate, pH ˜5; and
when the packed protein-A affinity chromatography column is intended for immediate use, the packed protein-A affinity chromatography column is equilibrated using a an equilibration buffer containing up to about 20 mM Tris and 100 mM NaCl, at pH 7.2.

6. The packed protein-A affinity chromatography column of claim 5 wherein, when operational backpressures of 5, 10, and 15.5 psi are generated during column operation, corresponding flow rates equal to, or greater than, 150 cm/hr, 220 cm/hr, and 311 cm/hr, respectively, are obtained.

7. A method for packing a chromatography column, the method comprising:
preparing a resin slurry by suspending a chromatography resin in a packing solution that contains a high-viscosity-imparting salt concentration of between 0.1 M and 2 M;
pouring the resin slurry into a column-chromatography tube to form the chromatography column;
packing the chromatography column by introducing packing-solution into the chromatography column; and
washing packing-solution from the chromatography column.

8. The method of claim 7, wherein the chromatography column is a protein-A affinity chromatography column and wherein the target molecule is an Fc-containing protein.

9. The method of claim 7, wherein the high-viscosity-imparting salt is a sulfate salt of sodium, potassium, or magnesium.

10. The method of claim 7, wherein the chromatography resin is an agarose-based resin.

11. The method of claim 7 wherein the packing-solution is continuously introduced into the chromatography column under pressure.

12. A packed chromatography column prepared by the method of claim 7.

13. A packed, agarose-resin-based, protein-A affinity chromatography column prepared by the method of claim 7 wherein, when operational backpressures of 5, 10, and 15.5 psi are generated during column operation, corresponding flow rates equal to, or greater than, 150 cm/hr, 220 cm/hr, and 311 cm/hr, respectively, are obtained.

14. A method for packing a chromatography column, the method comprising:
preparing a resin slurry by suspending a chromatography resin in a dilute aqueous solution;
pouring the resin slurry into a column-chromatography tube to form the chromatography column;
compressing the chromatography column by introducing a column-compressing solution containing a high-viscosity-imparting salt at a concentration of between 0.5 M and 2 M into the chromatography column; and
washing the column-compressing solution from the chromatography column.

15. The method of claim 14, wherein the chromatography column is a protein-A affinity chromatography column and wherein the target molecule is an Fc-containing protein.

16. The method of claim 14, wherein the high-viscosity-imparting salt is a sulfate salt of sodium, potassium, or magnesium.

17. The method of claim 14, wherein the chromatography resin is an agarose-based resin.

18. The method of claim 14 wherein the column-compressing solution is continuously introduced into the chromatography column under pressure.

19. A packed chromatography column prepared by the method of claim 14.

20. A packed, agarose-resin-based, protein-A affinity chromatography column prepared by the method of claim 14 wherein, when operational backpressures of 5, 10, and 15.5 psi are generated during column operation, corresponding flow rates equal to, or greater than, 150 cm/hr, 220 cm/hr, and 311 cm/hr, respectively, are obtained.

21. A method for packing a chromatography column, the method comprising:
preparing a resin slurry by suspending a chromatography resin in a packing solution that contains a high-viscosity-imparting Na₂SO₄ concentration of between 0.8 M and 1.2 M to form a high-viscosity resin slurry;
pouring the high-viscosity resin slurry into a column-chromatography tube to form the chromatography column;
packing the chromatography column by introducing packing-solution into the chromatography column; and
washing the packing-solution from the chromatography column.

22. The method of claim 21 wherein the packing-solution is continuously introduced into the chromatography column under pressure.
